(19) United States
(12) Patent Application Publication
(10) Pub. No.: US 2026/0268274 A1
(43) Pub. Date: Sep. 10, 2026

(54) SYSTEM AND METHODS FOR TRACKING AND VISUALIZING ASSETS OF A FACILITY

(71) Applicant: KoiReader Technologies, Inc., Dallas, TX (US)

(72) Inventors: Ashutosh Prasad, Dallas, TX (US); Vivek Prasad, Bengaluru (IN)

(21) Appl. No.: 19/557,257

(22) Filed: Mar. 5, 2026

Related U.S. Application Data
(60) Provisional application No. 63/767,684, filed on Mar. 6, 2025.

(51) Int. Cl. G06Q 10/087; G06Q 10/0631

(52) U.S. Cl. CPC G06Q 10/0877; G06Q 10/0631

(57) ABSTRACT

Techniques are described for tracking and visualizing assets at a storage facility. For example, an asset tracking system may be configured to associate a load with a vehicle based on sensor data captured when the vehicle picks up the load, and to track the location of the vehicle using overhead sensor devices that capture identifiers positioned on a top surface of the vehicle. The asset tracking system may utilize the sensor data to determine regions associated with loads (e.g., when a vehicle exits and re-enters a field of view of the overhead sensor devices), assign locations to loads based on pixel maps and known geometries between sensor positions and facility locations, and/or update an inventory tracking system with load locations.

### CROSS-REFERENCE TO RELATED APPLICATION

This application claims priority to U.S. Provisional Application No. 63/767,684 filed on Mar. 6, 2025 and entitled “SYSTEM AND METHODS FOR TRACKING AND VISUALIZING ASSETS OF A FACILITY,” which is incorporated herein by reference in its entirety.

### BACKGROUND

Storage facilities, such as shipping yards, processing plants, warehouses, distribution centers, ports, yards, transports, and the like store vast quantities of assets over a period of time. In some cases, such as when the facility becomes busy or full, assets, items, or loads may become lost causing further costs, delays, and other inefficiencies with regards to the operations of the facilities. In some cases, locating the desired assets may require walking a yard to locate a specific vehicle, container, or the like, which is time consuming and resource intensive.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a facility utilizing a lightweight asset tracking system, according to some implementations.

FIG. 2 is another example block diagram of a facility utilizing a lightweight asset tracking system, according to some implementations.

FIG. 3 is a flow diagram illustrating an example process associated with an asset tracking system, according to some implementations.

FIG. 4 is a flow diagram illustrating an example process associated with an asset tracking system, according to some implementations.

FIG. 5 is a flow diagram illustrating an example process associated with an asset tracking system, according to some implementations.

FIG. 6 is a flow diagram illustrating an example process associated with an asset tracking system, according to some implementations.

FIG. 7 is a flow diagram illustrating an example process associated with an asset tracking system, according to some implementations.

FIG. 8 is a flow diagram illustrating an example process associated with an asset tracking system, according to some implementations.

### DETAILED DESCRIPTION

Discussed herein are systems and devices for automating the tracking of positions and locations of assets (e.g., inventory, items, assets, vehicles, loads, personnel, pallets, or other resources and objects stored in a facility). In some examples, a tracking system or platform may be configured to utilize a lightweight approach that utilizes fewer computational resources than conventional systems that operate using inference models, large machine learning models, and item-by-item object tracking that requires the system to maintain the tracked object within the field of view during each operation.

Typically, these conventional systems require a large number of image devices that provide a clear field of view of an entire facility that are often in the thousands of square feet range with large numbers of vehicles and personnel being tracked in addition to each individual asset being tracked. For example, a medium sized facility may be between 50,000 and 100,000 square feet, employ 100-500 employees, utilize 10-100 robotic systems or autonomous systems (e.g., pickers, arms, automated storage and retrieval systems, mobile robotic systems, and the like), and utilize 20-100 vehicles (e.g., forklifts, pallet jacks, yard mules, and the like).

In conventional systems, tracking each of these assets over even these medium sized facilities not only requires massive amounts of hardware (e.g., processors, image devices, sensors systems, servers, and the like), the computational resource consumption to track thousands of assets can result in processing of terabytes of data per second, resulting in expensive and resource intensive systems that are often prohibitively expensive to maintain and operate. Accordingly, the system discussed herein may operate with fewer hardware resources (e.g., sensors, image devices, and the like) and, therefore, generate less data to process while still maintaining tracking of the assets as the assets are moved throughout the facility.

In some cases, the system discussed herein may be configured to utilize a sensor device associated with a vehicle (e.g., a forklift, pallet jack, autonomous retrieval system, and the like) to scan a load or pallet associated with one or more assets, such as items, inventory, and/or the like. The system may then associate an identifier associated with the vehicle with the scanned load or pallet. In some cases, the vehicle may be equipped with one or more identifiers (e.g., one or more alphanumerical characters, barcode, QR code, other machine-readable code, and/or the like). In some examples, the one or more identifiers may be positioned on a top surface of the vehicle such that the one or more identifiers can be scanned or read by one or more overhead image devices or other sensors.

In some implementations, once the system is associated with the load with a particular vehicle, the system may track the location of the vehicle using one or more overhead image devices that provide a top-down view of the facility. In some examples, the facility may be equipped with two or more overhead image devices per aisle or row. These two or more overhead image devices may be utilized to track the position, location, region, or the like of the vehicle as the vehicle transports the load throughout the facility. In some instances, unlike conventional systems, the facility may include blind spots or other areas outside the field of view of the overhead image devices. Accordingly, compared with conventional systems, the system discussed herein may utilize far fewer image devices or sensors than systems that can manually track the position of each asset within the facility.

In some examples, after scanning the load, the vehicle may depart a loading area, such as a dock door. As the vehicle exits the loading area, a first overhead image device may generate or capture data of the vehicle within its field of view, such as entering a first aisle (e.g., space between two or more racks). Eventually, the vehicle may exit the field of view of the first overhead image device as well as other overhead image devices of the facility. In this manner, the vehicle is exited the field of view of the system. In some cases, the vehicle will reenter the field of view of the system by entering a second aisle of the facility and the field of view of a second overhead image device. In these cases, the system may utilize image data generated by the second overhead image device of the identifier on the top surface of the vehicle to determine the identity of the vehicle. The system may then utilize the association between the vehicle and the load to determine the current location of the load (e.g., the location of the vehicle). In this manner, the system does not track both the load and the vehicle while the two assets are associated.

In some cases, such as when the vehicle is delivering the load to a specific location outside the field of view of the image devices, the system may determine that the vehicle, upon reentry into the field of view of the system, is no longer associated with the load. For instance, if the vehicle was outside of the field of view of the system for more than a predetermined period of time (e.g., a period of time associated with a delivery operation), the system may determine that the load was delivered to a region of the facility associated with the region outside the view of the system. In these cases, the system may assign the location of the load and any assets associated with the load to the region outside the view of the system and between the field of view of the first overhead image device and the field of view of the second overhead image device.

In other cases, such as when the vehicle is delivering the load to a region within the field of view of the system, the system may assign the region associated with the observed delivery event to the load and any assets associated with the load. However, in some cases, the system may desire a more precise location for each load as well as any assets associated with each of the loads. In these cases, the system may utilize a pixel map or predetermined digital twin of the facility together with the overhead image data to determine a specific location of the load/assets, such as a rack location. For instance, the system may capture image data (e.g., overhead image data) of the vehicle delivering the load to a specific location, such as a specific rack of a storage area or shelf. In these instances, the system may utilize the image data of, for instance, a height of an implement of the forklift together with the pixel mapping of the facility and one or more known geometries between the vehicle location and the overhead image device generating the image data of the delivery event.

In other specific cases, the one or more overhead image devices may also be equipped with radar sensors, lidar sensors, or other depth determining sensor systems. In these specific cases, the system may utilize the pixel map of the facility, the known geometries, and the depth data to determine the specific location (e.g., rack location or shelf location) to associate with the load as well as any assets associated with the load. In some of the examples, the image data together with the pixel map may be utilized to determine a specific pixel or pixels associated with the delivery event. The system may then utilize the specific pixels together with known geometries between the specific pixels and the position of the overhead image device to determine the specific location, such as the rack location or shelf location, that the assets were delivered to.

In some cases, each aisle may be equipped with two or more overhead image devices. In these cases, the system may utilize the pixel map together with known geometries between the specific pixels in the position of each (e.g., both) of the two or more overhead image devices to generate the specific location of the load and any assets associated with the load. In this manner, the system is able to track the location of the load and the assets associated with the load without requiring object tracking systems to track the location of the load in substantially real-time, thereby reducing the number of image devices, processing resources, and costs associated with determining the location of the load and the associated assets within the facility.

In some examples, prior to installation of the overhead image devices, the facility may be scanned using one or more mobile image devices. For example, the one or more lidar systems, such as a handheld device, drone mounted device, or device mounted on movable equipment or carts (including but not limited to autonomous equipment), may be utilized to scan each area of the facility (e.g., each rack, floor space or area, dock door, open storage area, load/unload area, and/or the like). The system may then utilize the mobile image data, such as the lidar data, to generate the digital twin of each individual area or portion of the facility. In some implementations, each area may be utilized to generate individual digital twins of the corresponding area and/or a total digital twin of the entire facility. In some cases, the individual digital twins of specific areas of the facility may be utilized with respect to the given area to reduce processing time and computational resource consumption associated with the system, as the map or digital twin of a portion of the facility may be used during the processing as opposed to the entire facility.

In the current example, the initial digital twin of a portion of the facility or the entire facility may be utilized to determine positioning of the overhead image devices for installation purposes. For instance, the digital twin or map of the facility may be utilized to determine a pixel mapping between each rack location or facility location and a given position on the ceiling of the facility (e.g., such as the potential location of an overhead image device). In some cases, the system may utilize the map or digital twin generated using the lidar data to calculate optimal or preferred positions of the overhead image device to installation (e.g., to reduce computational complexity when determining asset placement, delivery, or retrieval from one or more racks or other areas of the facility).

In the current example, the system may update the digital twin or map of the facility based on the overhead image data captured during operations and/or via additional data collected, such as by sensors associated with facility equipment or vehicles, facility personnel, and/or the like. In this manner, the original digital twin or pixel map may be generated using mobile lidar data (e.g., image data and depth data) and the digital twin and/or pixel map may be updated on an ongoing or periodic basis.

As described herein, the machine learned models may be generated using various machine learning techniques. For example, the models may be generated using one or more neural network(s). A neural network may be a biologically inspired algorithm or technique which passes input data (e.g., image and sensor data captured by the IoT computing devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model may be in the form of semantic per-pixel classifications (e.g., vehicle identifier, container identifier, driver identifier, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

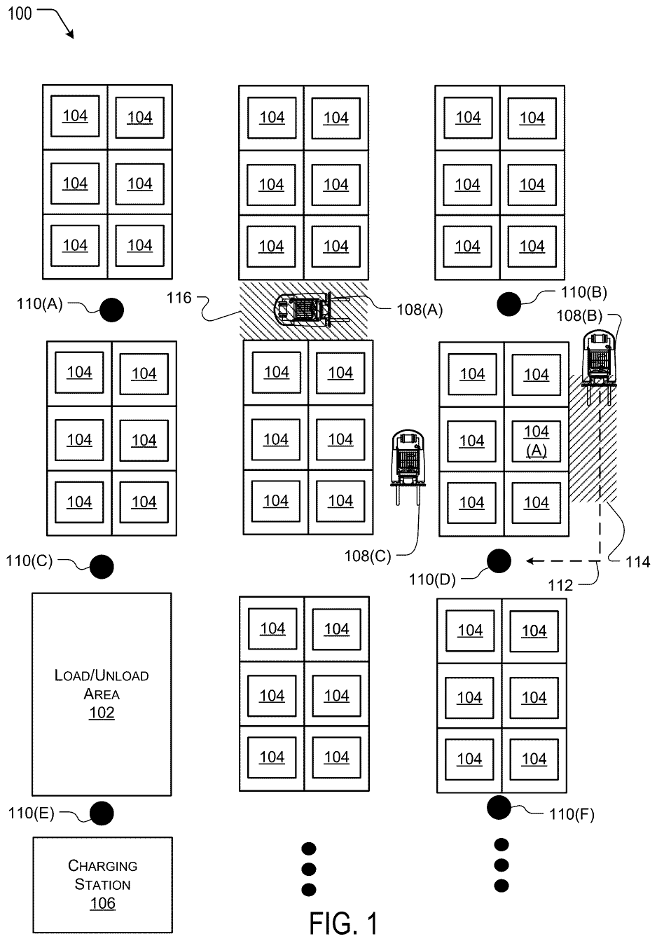

FIG. 1 is an example block diagram of a facility 100 utilizing a lightweight asset tracking system, according to some implementations. In the current example, the facility may include a load/unload area 102, such as one or more dock doors, as well as multiple storage locations, generally indicated by 104. The facility 100 may also include a charging station 106 and accommodate one or more vehicles, such as forklifts 108, configured to transport and arrange assets, such as items, inventory, supplies, resources, or the like, associated with the facility 100.

In the example, and overhead sensor devices, generally indicated by 110, are positioned along isle or walkways between storage locations 104, as illustrated. As discussed above, the system discussed herein may be configured to utilize a sensor device associated with each vehicle 108 (e.g., a forklift, pallet jack, autonomous retrieval system, and the like) to scan a load or pallet associated with one or more assets, such as items, inventory, and/or the like, as the vehicle 108 picks up the load for delivery to another location or region within the facility 100. The system may then associate an identifier associated with the vehicle 108 with the scanned load or pallet. For instance, within the loading area 102 the vehicle 108 may pick up a load for transportation and the operator of the vehicle 108 may utilize a handheld scanner associated with the vehicle 108 to scan the identifier on the load. The system may then, while the vehicle 108 is still within the loading area 102, associate the vehicle and the scanned load.

In some implementations, each vehicle 108 may be assigned one or more identifiers (e.g., one or more alphanumerical characters, barcode, QR code, other machine-readable code, and/or the like) which may be visible to the sensor devices 110 (e.g., one or more overhead cameras or image devices). In some examples, the one or more identifiers may be positioned on a top surface of the vehicles 108 such that the one or more identifiers can be scanned or read by one or more overhead sensor devices 110.

In some implementations, once the system has associated the load with a particular vehicle 108, the system may track the location of the vehicle 108 using one or more overhead sensor devices 110 that provide a top-down view of the facility 100. In some examples, the facility 100 may be equipped with two or more overhead sensor devices 110 for each isle or row, as illustrated. These two or more overhead sensor devices 110 may be utilized to track the position, location, region or the like of each vehicle 108 as the vehicles 108 transports loads throughout facility 100. In some instances, unlike the conventional system, the facility 100 may include blind spots or other areas outside the field of view of the overhead sensor devices 110. Accordingly, compared with conventional systems, the system discussed herein may utilize far fewer image devices or sensors and with systems that can manually track the position of each asset within the facility 100. For example, vehicle 108(C) may be in a blind spot or about to exit a blind spot and come into view of the sensor device 110(D) and/or 110(C). Likewise, vehicle 108(B) may be exiting the field of view of sensor device 110(B), as illustrated.

With respect to vehicle 108(B), the vehicle 108(B) may exit the field of view of the overhead device 110(B). In this manner, the vehicle 108(B) has exited the field of view of the system. In some cases, the vehicle 108(B) will reenter the field of view of the system by entering the field of view of the sensor device 110(D), as illustrated by path 112. In these cases, the system may utilize sensor data or image data generated by the sensor device 110(D) and the identifier on the top surface of the vehicle 108(B) to determine the identity of the vehicle 108(B) as the vehicle 108(B) re-enters the field of view of the system. The system may then utilize the association between the vehicle 108(B) and the load to determine the current location of the load (e.g., the location of the vehicle 108(B)). In this manner, the system does not track both the load and the vehicle 108(B) while the two assets are associated.

In some cases, such as when the vehicle 108(B) is delivering the load to a specific location outside the field of view of the overhead sensor devices 110, the system may determine that the vehicle 108(B), upon reentry into the field of the system, is no longer associated with the load. For instance, if the vehicle 108(B) was outside of the field of view of the system for more than a predetermined period of time (e.g., a period of time associated with a delivery operation), the system may determine that the load was delivered to a region 114 of the facility 100 associated with the region outside the view of the system. In these cases, the system may assign the location of the load and any assets associated with the load to the region 114 which is outside the view of the system and between the field of view of the overhead sensor device 110(B) and the field of view of the second overhead sensor device 110(D).

In other cases, such as when the vehicle 108(A) is delivering the load to a region 116 within the field of view of the system, the system may assign the region associated with the observed delivery event to the load and any assets associated with the load. However, in some cases, the system may desire a more precise location for each load as well as any assets associated with each of the loads. In these cases, the system may utilize a pixel map or predetermined digital twin of the facility 100 together with the overhead sensor data (e.g., from sensors 110(A) and 110(B)) to determine a specific location of the load/assets, such as a rack location. For instance, the system may capture image data (e.g., overhead image data) of the vehicle 108(A) delivering the load to a specific location, such as a specific rack of a storage or shelf. In these instances, the system may utilize the sensor data of for instance a height of an implement of the vehicle 108(A) together with the pixel mapping of the facility 100 and one or more known geometries between the vehicle location and the overhead sensor devices 110(A) and 110(B) generating the sensor data of the delivery event.

In other specific cases, the one or more overhead image devices may also be equipped with radar sensors, lidar sensors, or other depth determining sensor systems. In these specific cases, the system may utilize the pixel map of the facility 100, the known geometries, and the depth data to determine the specific location (e.g., rack location or shelf location) to associate with the load as well as any assets associated with the load. In some of the examples, the sensor data together with the pixel map may be utilized to determine a specific pixel or pixels associated with the delivery event. The system may then utilize the specific pixels together with known geometries between the specific pixels and the position of the overhead sensor devices 110(A) and 110(B) to determine the specific location, such as the rack location or shelf location, to which the assets were delivered.

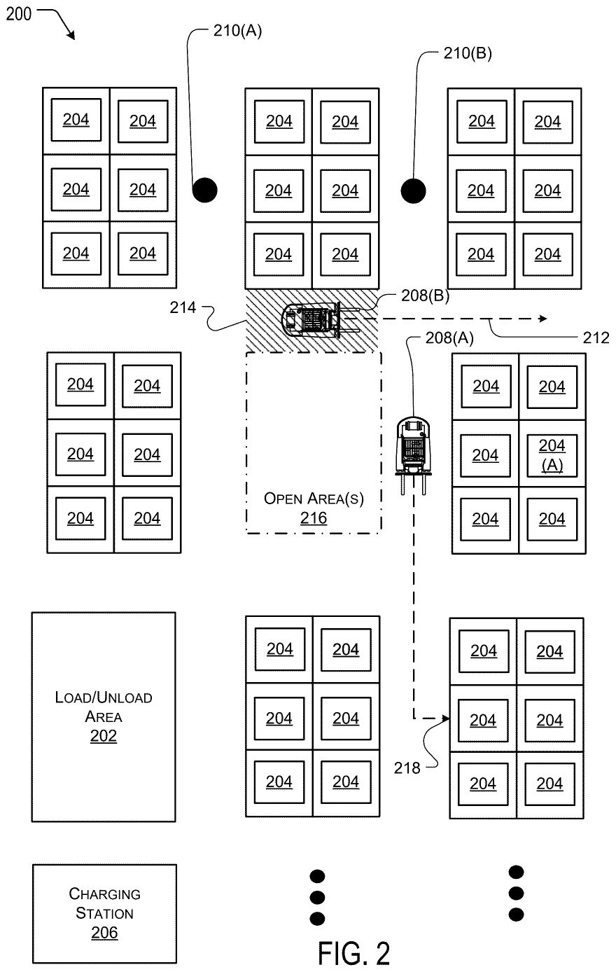

FIG. 2 is an example block diagram of a facility 200 utilizing a lightweight asset tracking system, according to some implementations. In the current example, the facility may include a load/unload area 202, such as one or more dock doors, an open area 216, as well as multiple storage locations, generally indicated by 204. The facility 200 may also include a charging station 206 and accommodate one or more vehicles 208, such as forklifts, configured to transport and arrange assets, such as items, inventory, supplies, resources, or the like, associated with the facility 200.

In the example, and overhead sensor devices, generally indicated by 210, are positioned along isle or walkways between storage locations 204, as illustrated. As discussed above, the system discussed herein may be configured to utilize a sensor device associated with each vehicle 208 (e.g., a forklift, pallet jack, autonomous retrieval system, and the like) to scan a load or pallet associated with one or more assets, such as items, inventory, and/or the like, as the vehicle 208 picks up the load for delivery to another location or region within the facility 200. The system may then associate an identifier associated with the vehicle 208 with the scanned load or pallet. For instance, within the loading area 202 the vehicle 208 may pick up a load for transportation and the operator of the vehicle 208 may utilize a handheld scanner associated with the vehicle 208 to scan the identifier on the load. The system may then, while the vehicle 208 is still within the loading area 202, associate the vehicle and the scanned load.

In some implementations, each vehicle 208 may be assigned one or more identifiers (e.g., one or more alphanumerical characters, barcode, QR code, other machine-readable code, and/or the like) which may be visible to the sensor devices 210 (e.g., one or more overhead cameras or image devices). In some examples, the one or more identifiers may be positioned on a top surface of the vehicles 208 such that the one or more identifiers can be scanned or read by one or more overhead sensor devices 210.

In some implementations, once the system has associated the load with a particular vehicle 208, the system may track the location of the vehicle 208 using one or more overhead sensor devices 210 that provide a top-down view of the facility 200. In some examples, the facility 200 may be equipped with two or more overhead sensor devices 210 for each isle or row, as illustrated. These two or more overhead sensor devices 210 may be utilized to track the position, location, region or the like of each vehicle 208 as the vehicles 208 transports loads throughout facility 200. In some instances, unlike the conventional system, the facility 200 may include blind spots or other areas outside the field of view of the overhead sensor devices 210. Accordingly, compared with conventional systems, the system discussed herein may utilize far fewer image devices or sensors and with systems that can manually track the position of each asset within the facility 200. For example, vehicle 208(B) may be in a blind spot or about to exit a blind spot and come into view of the sensor device 210(B).

With respect to vehicle 208(B), the vehicle 208(B) may exit the field of view of the overhead device 210(A). In this manner, the vehicle 208(B) has exited the field of view of the system. In some cases, the vehicle 208(B) will re-enter the field of view of the system by entering the field of view of the sensor device 210(B), as illustrated by path 212. In these cases, the system may utilize sensor data or image data generated by the sensor device 210(B) and the identifier on the top surface of the vehicle 208(B) to determine the identity of the vehicle 208(B) as the vehicle 208(B) re-enters the field of view of the system. The system may then utilize the association between the vehicle 208(B) and the load to determine the current location of the load (e.g., the location of the vehicle 208(B)). In this manner, the system does not track both the load and the vehicle 208(B) while the two assets are associated.

In some cases, such as when the vehicle 208(B) is delivering the load to a specific location outside the field of view of the overhead sensor devices 210, the system may determine that the vehicle 208(B), upon reentry into the field of the system, is no longer associated with the load. For instance, if the vehicle 208(B) was outside of the field of view of the system for more than a predetermined period of time (e.g., a period of time associated with a delivery operation), the system may determine that the load was delivered to a region 214 of the facility 200 associated with the region outside the view of the system. In these cases, the system may assign the location of the load and any assets associated with the load to the region 214 which is outside the view of the system and between the field of view of the overhead sensor device 210(A) and the field of view of the second overhead sensor device 210(B).

In other cases, such as when the vehicle 208(A) is delivering the load to a rack 218 of the storage area 204 within the field of view of the system, the system may assign the rack 218 associated with the observed delivery event to the load and any assets associated with the load. However, in some cases, the system may desire a more precise location for each load as well as any assets associated with each of the loads. In these cases, the system may utilize a pixel map or predetermined digital twin of the facility 200 together with the overhead sensor data (e.g., from sensor 110(B)) to determine a specific location of the load/assets, such as a rack location 218. For instance, the system may capture image data (e.g., overhead image data) of the vehicle 208(A) delivering the load to a specific location, such as a specific rack of a storage or shelf. In these instances, the system may utilize the sensor data of, for instance, a height of an implement of the vehicle 208(A) together with the pixel mapping of the facility 200 and one or more known geometries between the vehicle location and the overhead sensor device 110(B) generating the sensor data of the delivery event.

In other specific cases, the one or more overhead image devices may also be equipped with radar sensors, lidar sensor, or other depth determining sensor systems. In these specific cases, the system may utilize the pixel map of the facility 200, the known geometries, and the depth data to determine the specific location (e.g., rack location or shelf location) to associate with the load as well as any assets associated with the load. In some of the examples, the sensor data together with the pixel map may be utilized to determine a specific pixel or pixels associated with the delivery event. The system may then utilize the specific pixels together with known geometries between the specific pixels and the position of the overhead sensor devices 210(A) and 210(B) to determine the specific location, such as the rack location or shelf location, to which the assets were delivered.

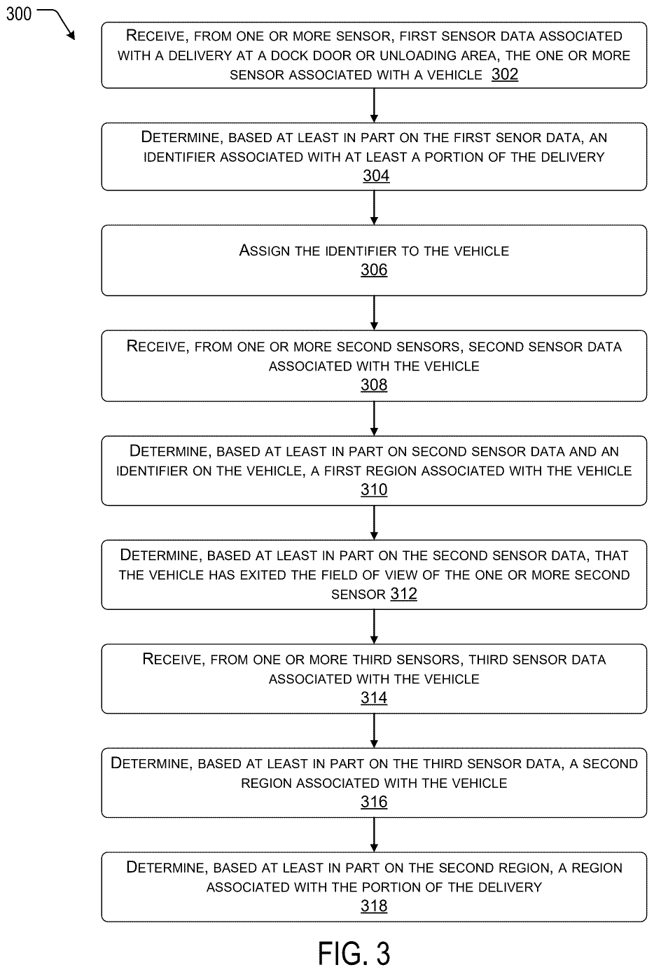

FIGS. 3-7 are flow diagrams illustrating example processes associated with the systems discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 3 is a flow diagram illustrating an example process 300 associated with an asset tracking system, according to some implementations. As discussed above, a system may be configured to utilize a first sensor associated with a vehicle, such as a forklift, pallet jack, or the like, to cause an association between a load and the vehicle. The system may also utilize overhead sensor devices, such as overhead image devices, together with an identifier of the vehicle associated with a top surface of the vehicle and visible to the overhead image devices. The system may also utilize time periods associated with known operations of the vehicle, the pixel map or digital twin of the facility, known geometries between each pixel of the pixel map and the position of the overhead sensor devices, and the like to determine a location within the facility to which a load has been delivered.

At 302, the system may receive, from one or more sensors, first sensor data associated with a delivery at a dock door or loading area. In some cases, the one or more sensors may be associated with a particular vehicle. For example, as a forklift or other vehicle picks up a portion of a delivery (e.g., a load), an operator of the vehicle may scan a code associated with the load. In some cases, the scan may be the first sensor data.

At 304, the system may determine, based at least in part on the first sensor data, an identifier associated with at least a portion (e.g., the load) of the delivery. The scan (e.g., the first sensor data) may include one or more identifiers of the load, the items associated with the load, or the like. In some cases, the first sensor data may include data representing a machine-readable code indicating the one or more identifiers and associated with the portion of the delivery.

At 306, the system may assign the identifier to the vehicle. For example, until a delivery event associated with the portion of the delivery is determined by the system, the system may associate the location of the vehicle as the current location of the portion of the delivery including the assets associated therewith.

At 308, the system may receive, from one or more second sensors, second sensor data associated with the vehicle. For example, the one or more second sensors may be one or more overhead image devices associated with the dock door or unload area. In these cases, the one or more second sensors may generate second sensor data including data representing the vehicle. In some cases, the second sensor data may be image data, depth data, lidar data, radar data, and/or the like.

At 310, the system may determine, based at least in part on the second sensor data and identifier on the vehicle, a first region associated the vehicle. For example, the first region may be the dock door region, and the initial isle that the vehicle enters after exiting the area associated with the dock door and/or the like.

At 312, the system may determine, based at least in part on the second sensor data, that the vehicle has exited the field of view of the one or more second sensors. For example, the vehicle may exit the field of view of the sensor associated with the dock door. In some cases, the vehicle may be outside the field of view of the system until the vehicle enters the field of view of another overhead sensor device.

At 314, the system may receive, from one or more third sensors, third sensor data associated with the vehicle. For example, the system may receive third sensor data such as image data of the vehicle including the identifier on the top surface of the vehicle or other surface of the vehicle. In some cases, the system may process the sensor data (e.g., segment, classify, characterize, and the like) to determine or read the identifier on the vehicle.

At 316, the system may determine, based at least in part on the third sensor data, a second region associated with the vehicle. For example, once the vehicle has been identified using the third sensor data the location of the vehicle may be determined either via the third sensor data and/or a known position of the third sensor.

At 318, the system may determine, based at least in part on the second region, a region associated with the portion of the delivery (e.g., the load). For example, if the vehicle is determined to still have custody of the portion of the delivery, then the second region may be assigned as the region associated with the portion of the delivery. However, if the vehicle is no longer in custody of the portion of the delivery, then a region between the field of view of the second sensor system and the field of view of the third sensor system may be assigned as the region associated with the portion of the delivery.

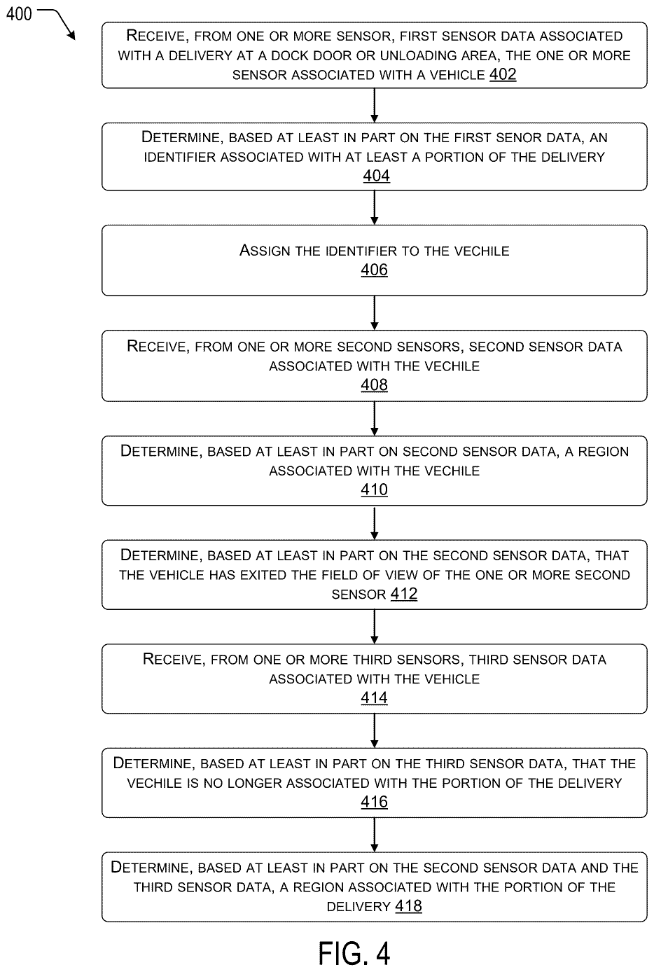

FIG. 4 is a flow diagram illustrating an example process 400 associated with an asset tracking system, according to some implementations. As discussed above, a system may be configured to utilize a first sensor associated with a vehicle, such as a forklift, pallet jack, or the like, to cause an association between a load and the vehicle. The system may also utilize overhead sensor devices, such as overhead image devices, together with an identifier of the vehicle associated with a top surface of the vehicle and visible to the overhead image devices. The system may also utilize time periods associated with known operations of the vehicle, the pixel map or digital twin of the facility, known geometries between each pixel of the pixel map and the position of the overhead sensor devices, and the like to determine a location within the facility to which a load has been delivered.

At 402, the system may receive, from one or more sensors, first sensor data associated with a delivery at a dock door or loading area. In some cases, the one or more sensors may be associated with a particular vehicle. For example, as a forklift or other vehicle picks up a portion of a delivery (e.g., a load), an operator of the vehicle may scan a code associated with the load. In some cases, the scan may be the first sensor data.

At 404, the system may determine, based at least in part on the first sensor data, an identifier associated with at least a portion (e.g., the load) of the delivery. The scan (e.g., the first sensor data) may include one or more identifiers of the of the load, the items associated with the load, or the like. In some cases, the first sensor data may include data representing a machine-readable code indicating the one or more identifiers and associated with the portion of the delivery.

At 406, the system may assign the identifier to the vehicle. For example, until a delivery event associated with the portion of the delivery is determined by the system, the system may associate the location of the vehicle as the current location of the portion of the delivery including the assets associated therewith.

At 408, the system may receive, from one or more second sensors, second sensor data associated with the vehicle. For example, the one or more second sensors may be one or more overhead image devices associated with the dock door or unload area. In these cases, the one or more second sensors may generate second sensor data including data representing the vehicle. In some cases, the second sensor data may be image data, depth data, lidar data, radar data, and/or the like.

At 410, the system may determine, based at least in part on the second sensor data and identifier on the vehicle, a first region associated the vehicle. For example, the first region may be the dock door region, and the initial isle that the vehicle enters after exiting the area associated with the dock door and/or the like.

At 412, the system may determine, based at least in part on the second sensor data, that the vehicle has exited the field of view of the one or more second sensors. For example, the vehicle may exit the field of view of the sensor associated with the dock door. In some cases, the vehicle may be outside the field of view of the system until the vehicle enters the field of view of another overhead sensor device.

At 414, the system may receive, from one or more third sensors, third sensor data associated with the vehicle. For example, the system may receive third sensor data such as image data of the vehicle including the identifier on the top surface of the vehicle or other surface of the vehicle. In some cases, the system may process the sensor data (e.g., segment, classify, characterize, and the like) to determine or read the identifier on the vehicle.

At 416, the system may determine, based at least in part on the third sensor data, that the vehicle is no longer associated with the portion of the delivery. For example, the system may determine based on the third sensor data, such as image data of the vehicle, that the vehicle is no longer in custody of the portion of the delivery. As another example, the system may determine based on a period of time that the vehicle was outside the field of view of the system that the delivery event occurred prior to the vehicle entering the field of view of the third sensor.

At 418, the system may determine, based at least in part on the second sensor data and the third sensor data, a region associated with the portion of the delivery. For example, the system may assign the region between the field of view of the second sensor and a field of view of the third sensor as the region associated with the portion of the delivery as well as any assets associated with the portion. As discussed above, in some cases the system may utilize a period of time that the vehicle was outside the field of view of the system to assist in determining a region assigned to the portion of the delivery.

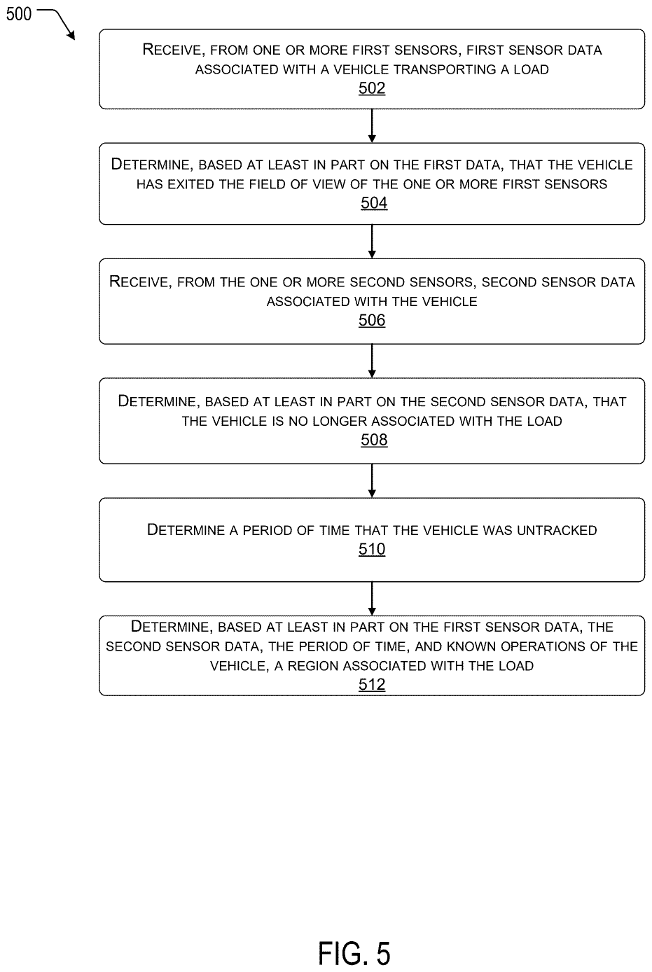

FIG. 5 is a flow diagram illustrating an example process 500 associated with an asset tracking system, according to some implementations. As discussed above, a system may be configured to utilize a first sensor associated with a vehicle, such as a forklift, pallet jack, or the like, to cause an association between a load and the vehicle. The system may also utilize overhead sensor devices, such as overhead image devices, together with an identifier of the vehicle associated with a top surface of the vehicle and visible to the overhead image devices. The system may also utilize time periods associated with known operations of the vehicle, the pixel map or digital twin of the facility, known geometries between each pixel of the pixel map and the position of the overhead sensor devices, and the like to determine a location within the facility to which a load has been delivered.

At 502, the system may receive, from one or more first sensors, first sensor data associated with a vehicle transporting a load. For example, the first sensor data may be image data associated with the vehicle accepting or picking up the load. In some cases, the system may process the image data, such as via segmentation, classification, identification, and/or the like, to determine that the load should be associated with the vehicle. In other words, the system may determine that a pickup event has occurred and includes the vehicle and the load (e.g., any assets associated with).

At 504, the system may determine, based at least in part on the first data, that the vehicle has exited the field of view of the one or more sensors. For example, the vehicle may transport the load around a corner or down an isle that includes one or more storage racks that obstruct, at least partially, the field of view of the one or more first sensors.

At 506, the system may receive, from the one or more second sensors, second sensor data associated with the vehicle. For example, the vehicle may have transported the load into the field of view of the second sensor as the vehicle rounds the corner of the rack.

At 508, the system may determine, based at least in part on the second sensor data, that the vehicle is no longer associated with the load. For example, the system may parse the second sensor data to determine the identity of the vehicle, such as via determining a machine-readable identifier associated with exterior surface of the vehicle within image data captured by the second sensor. The system may also process the second sensor data to determine the load is no longer associated with the vehicle. For example, the system may process the image data generated by the second sensor to determine that the implement of the vehicle is no longer occupied by the load (e.g., the implement is empty).

At 510, the system may determine a period of time that the vehicle was untracked or outside the field of view of the system. For example, the system may determine that the vehicle was outside the field of view for a regular number of seconds or minutes based at least in part on a timestamp associated with the first sensor data and a time stamp associated with the second sensor data.

At 512, the system may determine, based at least in part on the first sensor data, the second sensor data, the period of time, and known operations of the vehicle, a region associated with the load. For example, the system may determine the region or rack based at least in part on a location of the first sensor and a location of the second sensor as well as the position of the vehicle exiting the field of view of the first sensor and the position of the vehicle entering the field of view of the second sensor. The system may also determine an estimated position or rack location based at least in part on the period of time and various times associated with known operations of the vehicle. For instance, the system may know the placement of the load on a low rack may be between X seconds and Y seconds while a placement of the load on rack may be between A seconds and B seconds. Accordingly, determining the region or position of the load may be based on the period of time compared to the known operational times of the vehicle.

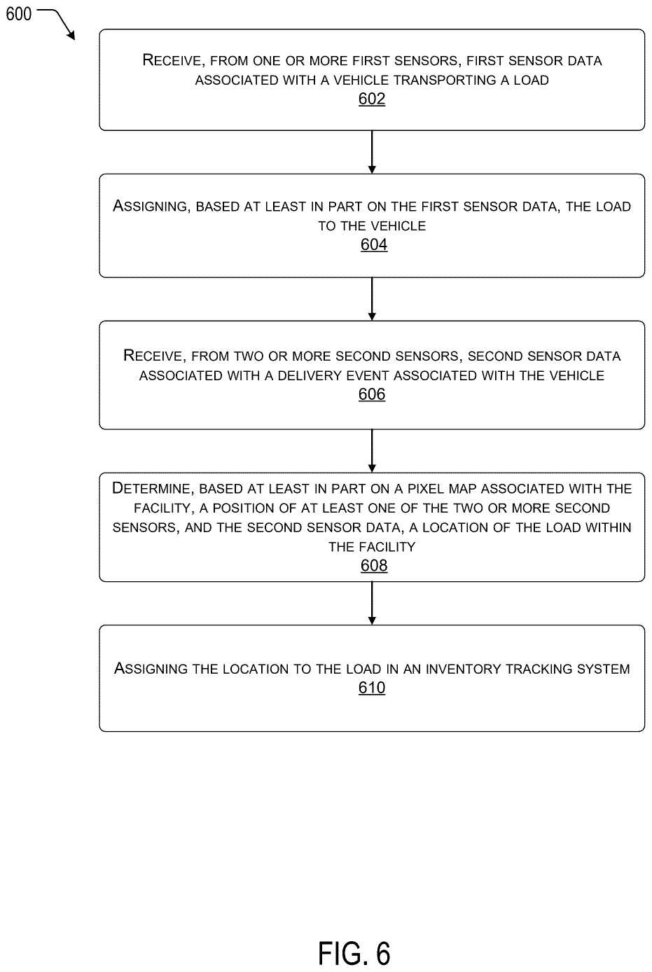

FIG. 6 is a flow diagram illustrating an example process 600 associated with an asset tracking system, according to some implementations. As discussed above, a system may be configured to utilize a first sensor associated with a vehicle, such as a forklift, pallet jack, or the like, to cause an association between a load and the vehicle. The system may also utilize overhead sensor devices, such as overhead image devices, together with an identifier of the vehicle associated with a top surface of the vehicle and visible to the overhead image devices. The system may also utilize time periods associated with known operations of the vehicle, the pixel map or digital twin of the facility, known geometries between each pixel of the pixel map and the position of the overhead sensor devices, and the like to determine a location within the facility to which a load has been delivered.

At 602, the system may receive, from one or more first sensors, first sensor data associated with a vehicle transporting a load. For example, the first sensor data may be image data associated with the vehicle accepting picking up the load. In some cases, the system may process the image data, such as via segmentation, classification, identification, and/or the like, to determine that the load should be associated with the vehicle. In other words, the system may determine that a pickup event has occurred and includes the vehicle and the load (e.g., any assets associated with).

At 604, the system may assign, based at least in part on the first sensor data, the load to the vehicle. For example, an operator of the vehicle may scan a machine-readable code associated with the load and the system may assign any assets associated with the load to the vehicle, thereby assigning the location of the assets associated with the load to corresponds to the location of the vehicle within the facility.

At 606, the system may receive, from two or more second sensors, second sensor data associated with the delivery event associated with the vehicle and the load. For example, the system may determine that operations be performed by the vehicle corresponds to operations performed during delivery event. In some cases, the system may utilize one or more machine learned models trained on operational data and image data of vehicle performing operations associated with accepting, transporting, and delivering loads to various different locations within a facility. In these cases, the one or more machine learned models may output a status of the vehicle such as an indication that the delivery event performed.

At 608, the system may determine, based at least in part on the pixel map associated with the facility, a position of the at least one of the two or more second sensors, and the second sensor data, a location of the load within the facility. For example, the system may utilize the known geometries between the position of the at least one of the two or more second sensors and a pixel associated with a pixel map corresponding to an image of the vehicle performing the delivery event.

At 610, the system may assign the location to the load in an inventory tracking system. For example, the system may decouple the load from the vehicle and assign the location of the load to the location determine at 608.

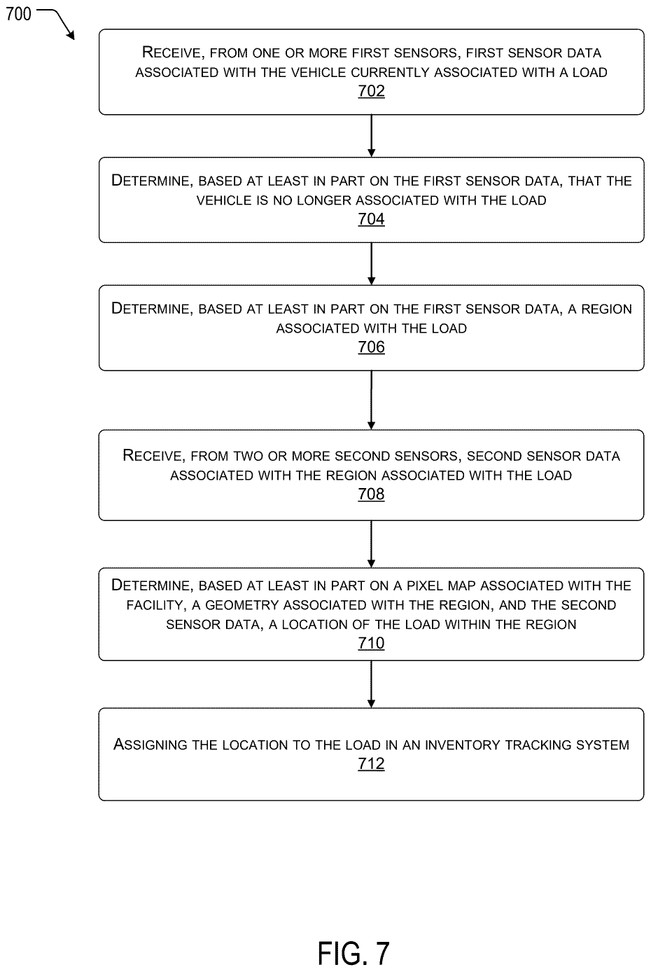

FIG. 7 is a flow diagram illustrating an example process 700 associated with an asset tracking system, according to some implementations. As discussed above, a system may be configured to utilize a first sensor associated with a vehicle, such as a forklift, pallet jack, or the like, to cause an association between a load and the vehicle. The system may also utilize overhead sensor devices, such as overhead image devices, together with an identifier of the vehicle associated with a top surface of the vehicle and visible to the overhead image devices. The system may also utilize time periods associated with known operations of the vehicle, the pixel map or digital twin of the facility, known geometries between each pixel of the pixel map and the position of the overhead sensor devices, and the like to determine a location within the facility to which a load has been delivered.

At 702, the system may receive, from one or more first sensors, first sensor data associated with a vehicle associated with a load. For example, the first sensor data may be image data associated with the vehicle accepting, hauling, or picking up the load. In some cases, the system may process the image data, such as via segmentation, classification, identification, and/or the like, to determine that the load should be associated with the vehicle. In other words, the system may determine that a pickup event has occurred and includes the vehicle and the load (e.g., any assets associated with).

At 704, the system may determine, based at least in part on the second sensor data, that the vehicle is no longer associated with the load. For example, the system may parse the second sensor data to determine the identity of the vehicle, such as via determining a machine-readable identifier associated with exterior surface of the vehicle within image data captured by the second sensor. The system may also process the second sensor data to determine the load is no longer associated with the vehicle. For example, the system may process the image data generated by the second sensor to determine that the implement of the vehicle is no longer occupied by the load (e.g., the implement is empty).

At 706, the system may determine, based at least in part on the first sensor data, a region associated with the load. For example, the system may utilize a period of time that the vehicle was outside the field of view of the system to assist in determining a region assigned to the load.

At 708, the system may receive, from two or more second sensors, second sensor data associated with the delivery event associated with the vehicle and the load. For example, the two or more sensors may be utilized for top down imaging of the facility while the first sensor may be used for tracking of assets, such as the vehicle. In other words, the two or more second sensors may be different types of sensors than the first sensor, such as less expensive, generating less data (e.g., fewer pixels, lower resolution, and the like). In some cases, the system may determine that operations be performed by the vehicle corresponds to operations performed during delivery event. In some cases, the system may utilize one or more machine learned models trained on operational data and image data of vehicle performing operations associated with accepting, transporting, and delivering loads to various different locations within a facility. In these cases, the one or more machine learned models may output a status of the vehicle such as an indication that the delivery event performed.

At 710, the system may determine, based at least in part on the pixel map associated with the facility, a geometry associated with the region (such as a position of the at least one of the two or more second sensors), and the second sensor data, a location of the load within the region. For example, the system may utilize the known geometries between the position of the at least one of the two or more second sensors and a pixel associated with a pixel map corresponding to an image of the vehicle performing the delivery event.

At 712, the system may assign the location to the load in an inventory tracking system. For example, the system may decouple the load from the vehicle and assign the location of the load to the location determine at 710.

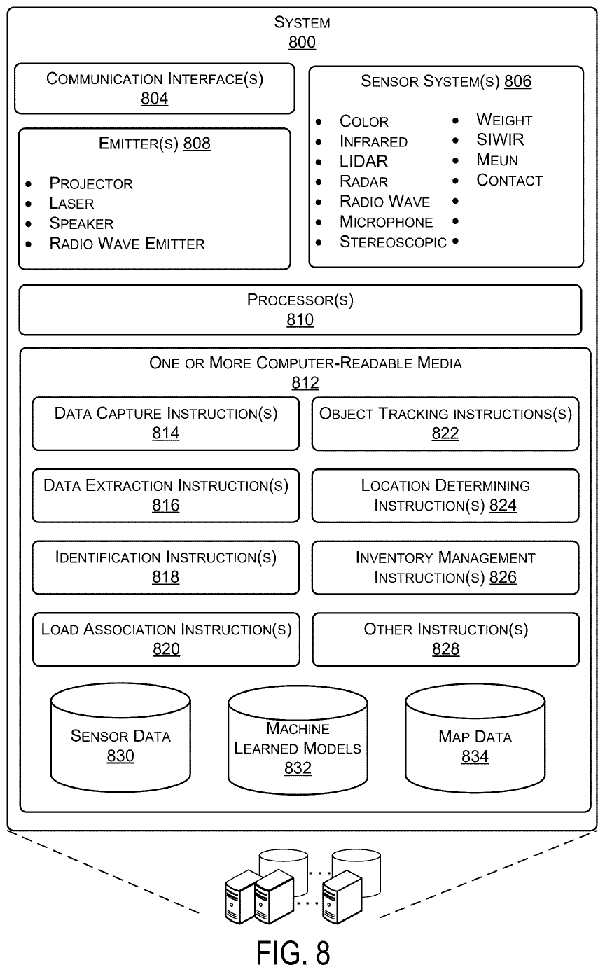

FIG. 8 is an example inventory management or tracking system 800 that may implement the techniques described herein according to some implementations. The system 800 may include one or more communication interface(s) 804 (also referred to as communication devices and/or modems), one or more sensor system(s) 806, and one or more emitter(s) 808.

The system 800 can include one or more communication interfaces(s) 804 that enable communication between the system 800 and one or more other local or remote computing device(s) or remote services, such as cloud-based services. For instance, the communication interface(s) 804 can facilitate communication with other proximate sensor systems and/or other facility systems. The communications interfaces(s) 804 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The one or more sensor system(s) 806 may be configured to capture the sensor data 830 associated with a facility. In at least some examples, the sensor system(s) 806 may include thermal sensors, time-of-flight sensors, location sensors, LIDAR sensors, SIWIR sensors, radar sensors, sonar sensors, infrared sensors, cameras (e.g., RGB, IR, intensity, depth, etc.), Muon sensors, microphone sensors, environmental sensors (e.g., temperature sensors, humidity sensors, light sensors, pressure sensors, etc.), and the like. In some examples, the sensor system(s) 806 may include multiple instances of each type of sensors. For instance, camera sensors may include multiple cameras disposed at various locations.

The system 800 may also include one or more emitter(s) 808 for emitting light and/or sound. By way of example and not limitation, the emitters in this example include light, illuminators, lasers, patterns, such as an array of light, audio emitters, and the like. For example, the system 800 may include one or more depth sensors.

The system 800 may include one or more processors 810 and one or more computer-readable media 812. Each of the processors 810 may itself comprise one or more processors or processing cores. The computer-readable media 812 is illustrated as including memory/storage. The computer-readable media 812 may include volatile media (such as random access memory (RAM)) and/or nonvolatile media (such as read only memory (ROM), Flash memory, optical disks, magnetic disks, and so forth). The computer-readable media 812 may include fixed media (e.g., RAM, ROM, a fixed hard drive, and so on) as well as removable media (e.g., Flash memory, a removable hard drive, an optical disc, and so forth). The computer-readable media 812 may be configured in a variety of other ways as further described below.

Several modules such as instructions, data stores, and so forth may be stored within the computer-readable media 812 and configured to execute on the processors 810. For example, as illustrated, the computer-readable media 812 stores data capture instructions 814, data extraction instructions 816, identification instructions 818, load association instructions 820, object tracking instructions 822, location determining instruction 824, inventory management instructions 826, as well as other instructions 828, such as an operating system. The computer-readable media 812 may also be configured to store data, such as sensor data 830, machine learned models 832, and map data 834 (e.g., pixel maps, digital twins, virtual models, and the like), as well as other data.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

### EXAMPLE CLAUSES

A. A method comprising: receiving, from one or more first sensors, first sensor data associated with a vehicle taking custody of a load; determining, based at least in part on the first sensor data, an identifier associated with at least a portion of the load; assigning the identifier to the vehicle; receiving, from one or more second sensors, second sensor data associated with the vehicle; determining, based at least in part on the second sensor data and an identifier on the vehicle, a first region associated with the vehicle; determining, based at least in part on the second sensor data, that the vehicle has exited a field of view of the one or more second sensors; receiving, from one or more third sensors, third sensor data associated with the vehicle; determining, based at least in part on the third sensor data, a second region associated with the vehicle; and determining, based at least in part on the second region, a region associated with the portion of the load.
B. The method of paragraph A, wherein the first sensor data comprises data representing a machine-readable code associated with the portion of the load.
C. The method of paragraph A, wherein the vehicle is configured to carry one or more containers or pallets throughout a facility associated with the load.
D. The method of paragraph A, wherein the identifier on the vehicle is positioned on a top surface of the vehicle.
E. The method of paragraph A, further comprising determining, based at least in part on the third sensor data, that the vehicle is no longer associated with the portion of the load.
F. The method of paragraph E, wherein determining the region associated with the portion of the load is based at least in part on a period of time that the vehicle was outside the field of view of the one or more second sensors and the one or more third sensors.
G. A method comprising: receiving, from one or more first sensors, first sensor data associated with a vehicle transporting a load within a facility; determining, based at least in part on the first sensor data, that the vehicle has exited a field of view of the one or more first sensors; receiving, from one or more second sensors, second sensor data associated with the vehicle; determining, based at least in part on the second sensor data, that the vehicle is no longer associated with the load; determining a period of time that the vehicle was outside the field of view; and determining, based at least in part on the first sensor data, the second sensor data, the period of time, and known operations of the vehicle, a region associated with the load.
H. The method of paragraph G, wherein the known operations of the vehicle comprise at least one of a placement time associated with delivering the load to one or more rack levels and one or more rack positions.
I. The method of paragraph G, wherein determining that the vehicle is no longer associated with the load comprises processing the second sensor data to determine that an implement of the vehicle is no longer occupied by the load.
J. The method of paragraph G, wherein determining the region associated with the load is based at least in part on a stored digital twin of the facility.
K. The method of paragraph J, wherein the region associated with the load comprises a region between a field of view of the one or more first sensors and a field of view of the one or more second sensors.
L. The method of paragraph G, further comprising: identifying the vehicle based at least in part on a machine-readable identifier positioned on an exterior surface of the vehicle; and associating the load with the vehicle based at least in part on the machine-readable identifier.
M. The method of paragraph L, wherein the machine-readable identifier is positioned on a top surface of the vehicle such that the machine-readable identifier is visible to the one or more second sensors.
N. A method comprising: receiving, from one or more first sensors, first sensor data associated with a vehicle transporting a load within a facility; assigning, based at least in part on the first sensor data, the load to the vehicle; receiving, from two or more second sensors, second sensor data associated with a delivery event associated with the vehicle; determining, based at least in part on a map associated with the facility, a position of at least one of the two or more second sensors, and the second sensor data, a location of the load within the facility; and assigning the location to the load in an inventory tracking system.
O. The method of paragraph N, wherein the map is a pixel map.
P. The method of paragraph O, wherein determining the location of the load within the facility comprises utilizing known geometries between the position of the at least one of the two or more second sensors and a pixel associated with the pixel map corresponding to an image of the vehicle performing the delivery event.
Q. The method of paragraph N, wherein the map is a digital twin of the facility.
R. The method of paragraph Q, wherein the digital twin is generated based at least in part on lidar data captured by one or more mobile image devices.
S. The method of paragraph N, wherein the location of the load comprises a rack location or a shelf location within the facility.
T. The method of paragraph N, further comprising: determining, based at least in part on the second sensor data, a height of an implement of the vehicle during the delivery event; and wherein determining the location of the load within the facility is based at least in part on the height of the implement.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, from one or more first sensors, first sensor data associated with a vehicle taking custody of a load;
determining, based at least in part on the first sensor data, an identifier associated with at least a portion of the load;
assigning the identifier to the vehicle;
receiving, from one or more second sensors, second sensor data associated with the vehicle;
determining, based at least in part on the second sensor data and an identifier on the vehicle, a first region associated with the vehicle;
determining, based at least in part on the second sensor data, that the vehicle has exited a field of view of the one or more second sensors;
receiving, from one or more third sensors, third sensor data associated with the vehicle;
determining, based at least in part on the third sensor data, the vehicle is no longer in custody of the portion of the load;
determining, based at least in part on the third sensor data, a second region associated with the vehicle; and
determining, based at least in part on the second region, a region associated with the portion of the load.

2. The method of claim 1, wherein the first sensor data comprises data representing a machine-readable code associated with the portion of the load.

3. The method of claim 2, wherein the vehicle is configured to carry one or more containers or pallets throughout a facility associated with the load.

4. The method of claim 1, wherein the identifier on the vehicle is positioned on a top surface of the vehicle.

5. The method of claim 1, further comprising determining, based at least in part on the third sensor data, that the vehicle is no longer associated with the portion of the load.

6. The method of claim 5, wherein determining the region associated with the portion of the load is based at least in part on a period of time that the vehicle was outside the field of view of the one or more second sensors and the one or more third sensors.

7. A system comprising:
one or more processors; and
one or more computer-readable media storing instructions that, when executed by the one or more processors, cause the one or more processors to perform operations comprising:
receiving, from one or more first sensors, first sensor data associated with a vehicle transporting a load within a facility;
determining, based at least in part on the first sensor data, that the vehicle has exited a field of view of the one or more first sensors;
receiving, from one or more second sensors, second sensor data associated with the vehicle;
determining, based at least in part on the second sensor data, that the vehicle is no longer associated with the load;
determining a period of time that the vehicle was outside the field of view; and
determining, based at least in part on the first sensor data, the second sensor data, the period of time, and known operations of the vehicle, a region associated with the load.

8. The system of claim 7, wherein the known operations of the vehicle comprise at least one of a placement time associated with delivering the load to one or more rack levels and one or more rack positions.

9. The system of claim 7, wherein determining that the vehicle is no longer associated with the load comprises processing the second sensor data to determine that an implement of the vehicle is no longer occupied by the load.

10. The system of claim 7, wherein determining the region associated with the load is based at least in part on a stored digital twin of the facility.

11. The system of claim 10, wherein the region associated with the load comprises a region between a field of view of the one or more first sensors and a field of view of the one or more second sensors.

12. The system of claim 7, wherein the operations further comprise:
identifying the vehicle based at least in part on a machine-readable identifier positioned on an exterior surface of the vehicle; and
associating the load with the vehicle based at least in part on the machine-readable identifier.

13. The system of claim 12, wherein the machine-readable identifier is positioned on a top surface of the vehicle such that the machine-readable identifier is visible to the one or more second sensors.

14. One or more computer-readable media storing instructions that, when executed by one or more processors, cause the one or more processors to perform operations comprising:
receiving, from one or more first sensors, first sensor data associated with a vehicle transporting a load within a facility;
assigning, based at least in part on the first sensor data, the load to the vehicle;
receiving, from two or more second sensors, second sensor data associated with a delivery event associated with the vehicle;
determining, based at least in part on a map associated with a facility, a position of at least one of the two or more second sensors, and the second sensor data, a location of the load within the facility; and
assigning the location to the load in an inventory tracking system.

15. The one or more computer-readable media of claim 14, wherein the map is a pixel map.

16. The one or more computer-readable media of claim 15, wherein determining the location of the load within the facility comprises utilizing known geometries between the position of the at least one of the two or more second sensors and a pixel associated with the pixel map corresponding to an image of the vehicle performing the delivery event.

17. The one or more computer-readable media of claim 16, wherein the map is a digital twin of the facility.

18. The one or more computer-readable media of claim 17, wherein the digital twin is generated based at least in part on lidar data captured by one or more mobile image devices.

19. The one or more computer-readable media of claim 14, wherein the location of the load comprises a rack location or a shelf location within the facility.

20. The one or more computer-readable media of claim 14, wherein the operations further comprise:
determining, based at least in part on the second sensor data, a height of an implement of the vehicle during the delivery event; and
wherein determining the location of the load within the facility is based at least in part on the height of the implement.
